(19) United States
(12) Patent Application Publication
(10) Pub. No.: US 2013/0208122 A1
(43) Pub. Date: Aug. 15, 2013

(54) COMMODITY READING APPARATUS AND COMMODITY READING METHOD

(71) Applicant: TOSHIBA TEC KABUSHIKI KAISHA, (US)

(72) Inventors: Hitoshi Iizaka, Shizuoka-ken (JP); Hidehiro Naito, Shizuoka-ken (JP); Hiroshi Sugasawa, Miyagi-ken (JP); Atsushi Nakamoto, Shizuoka-ken (JP)

(73) Assignee: TOSHIBA TEC KABUSHIKI KAISHA, Tokyo (JP)

(21) Appl. No.: 13/748,996

(22) Filed: Jan. 24, 2013

(30) Foreign Application Priority Data
Jan. 30, 2012 (JP) 2012-016327

(51) Int. Cl. H04N 7/18

(52) U.S. Cl. CPC H04N 7/18
USPC 348/150

(57) ABSTRACT

A commodity reading apparatus comprises a display section, an image capturing unit configured to photograph a commodity in a photographing area to output an image of the photographing area, a recognition unit configured to recognize the commodity included in the image outputted by the image capturing unit, an area display unit configured to display an image display area smaller in size than the photographing area photographed by the image capturing unit on the screen of the display section, and an image display unit configured to display the image photographed by the image capturing unit on the screen in a manner that the center of the image is located at the center of the image display area.

### CROSS-REFERENCE TO RELATED APPLICATION

This application is based upon and claims the benefit of priority from Japanese Patent Application No. 2012-016327, filed Jan. 30, 2012, the entire contents of which are incorporated herein by reference.

### FIELD

Embodiments described herein relate generally to a commodity reading apparatus using an image capturing unit, and a commodity reading method by the commodity reading apparatus.

### BACKGROUND

There is a commodity reading apparatus that recognizes an object such as a commodity based on an image photographed by an image capturing unit such as a CCD camera. Such commodity reading apparatus has an image capturing unit within the apparatus, and also has a reading window in the housing of the apparatus. And the image capturing unit uses an area that provides an image from the reading window via an image lens as an imaging range. Therefore, for example, in case that a commodity is recognized by using such commodity reading apparatus, an operator holds the commodity over the reading window of the apparatus as to take an image of the overall appearance of the commodity by the image capturing unit.

It is not a burden for an operator skilled in the operation of the commodity reading apparatus to hold the commodity over the reading window so as to take an image of the overall appearance of the commodity by the image capturing unit. However, an operator being unskilled may be not sure which direction the commodity is moved, this may become a burden.

### BRIEF DESCRIPTION OF THE DRAWINGS

FIG. 1 is an external view of a store checkout system according to one embodiment;

FIG. 2 is a block diagram showing a hardware components of a commodity reading apparatus and a POS terminal that belong to the same system shown in FIG. 1;

FIG. 3 is a schematic diagram showing a data structure of a commodity data file used in the same system;

FIG. 4 is a schematic diagram showing a main memory area formed in a RAM of the commodity reading apparatus of the same system;

FIG. 5 is a schematic diagram showing a correspondence relationship between a photographing area of an imaging unit and an image display area displayed on a display unit in the commodity reading apparatus of the same system;

FIG. 6 is a schematic diagram showing a functional construction achieved by a CPU in the commodity reading apparatus of the same system;

FIG. 7 is a flowchart showing the main procedure of an information processing executed by the CPU according to a commodity reading program in the commodity reading apparatus of the same system;

FIG. 8 is a plan view showing one example of an image recognition screen displayed on a touch panel in the commodity reading apparatus of the same system;

FIG. 9 is a schematic diagram showing a relationship between an image within the imaging area and an image displayed in an image display area of the image recognition screen in the commodity reading apparatus of the same system;

FIG. 10 is a schematic diagram showing an image displayed in the image recognition area of the image recognition screen in the commodity reading apparatus of the same system;

FIG. 11 is a schematic diagram showing another example of the image recognition screen; and

FIG. 12 is a schematic diagram showing further another example of the image recognition screen.

### DETAILED DESCRIPTION

According to one embodiment, a commodity reading apparatus comprises a display section having a screen, an image capturing unit configured to photograph a commodity in a photographing area to output an image of the photographing area, a recognition unit configured to recognize the commodity included in the image outputted by the image capturing unit, an area display unit configured to display an image display area smaller in size than the photographing area photographed by the image capturing unit on the screen of the display section, and an image display unit configured to display the image photographed by the image capturing unit on the screen in a manner that the center of the image is located at the center of the image display area.

Hereinafter, an embodiment of the commodity reading apparatus is described by referring to the accompanying drawings. The embodiment may be applied to a vertical commodity reading apparatus that is vertically installed on the checkout counter arranged at a store such as a supermarket.

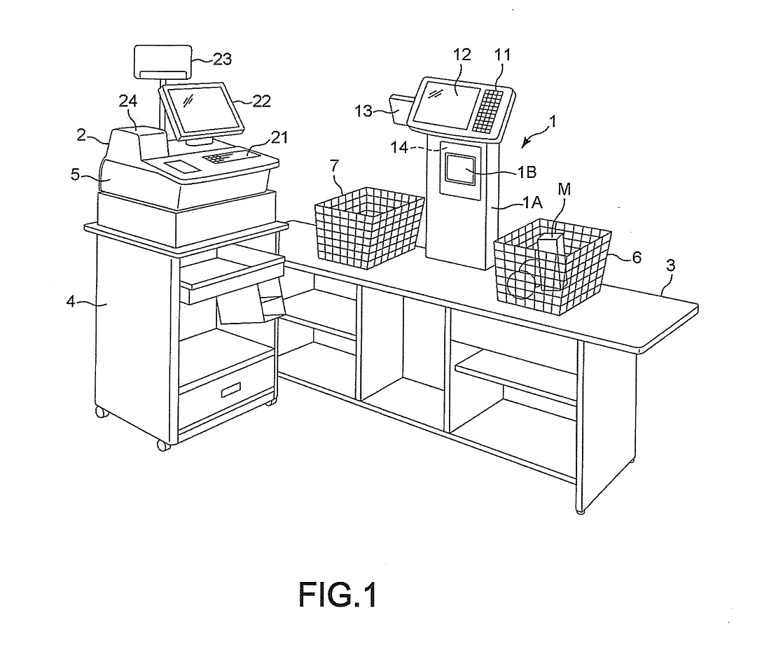

FIG. 1 is an external view of a store checkout system according to one embodiment. This system includes a commodity reading apparatus 1 as a registration unit, and a POS (Point Of Sales) terminal 2 as a settlement unit. The commodity reading apparatus 1 is installed on a checkout counter 3. The POS terminal 2 is arranged on a cash drawer 5 mounted on a registration desk 4. The commodity reading apparatus 1 and the POS terminal 2 are electrically connected with each other via a communication cable (not shown)

The commodity reading apparatus 1 comprises a keyboard 11, a touch panel 12 and a display for customer 13 as the apparatus necessary for commodity registration. These display and operating devices (the keyboard 11, the touch panel 12, and the display for customer 13) are installed in a rectangular-shaped housing 1A having a relatively thin length that constitutes the main body of the commodity reading apparatus 1.

An image capturing unit 14 is built in the housing 1A. In addition, a rectangular-shaped reading window 1B is formed at the front surface of the housing 1A. The image capturing unit 14 includes a CCD (Charge Coupled Device) photography element as an area image sensor and its drive circuit, and an image lens for focusing an image at a photographing area S to the CCD image sensor. The photographing area S refers to an area of a frame image that is focused on the area of the CCD image sensor from a reading window 1B through the image lens. The image capturing unit 14 outputs an image of the photographing area S that is focused on the CCD image sensor via the image lens.

The POS terminal 2 includes a keyboard 21, a display for operator 22, a display for customer 23, and a receipt printer 24 as a device necessary for the settlement.

The checkout counter 3 is of an elongated shape along a customer passageway at its back side. In a manner of approximately perpendicular to the checkout counter 3, the registration desk 4 is placed at an end of the checkout counter 3 at the downstream side with respect to the movement direction of the customer. And, a space partitioned by the front side of the checkout counter 3 and the front side of the registration desk 4 is for a shop clerk, i.e., casher who is in charge of the checkout.

The housing 1A of the commodity reading apparatus 1 is vertically arranged at approximately center of the checkout counter 3 in a manner that the keyboard 11, the touch panel 12 and the reading window 1B respectively face at the cashier side (front side). The display for customer 13 of the commodity reading apparatus 1 is arranged at the housing 1A toward the customer pathway.

A placing surface of the checkout counter 3 at the upper stream side of the commodity reading apparatus 1 in the customer moving direction is a space for placing a shopping basket 6 into which an un-registered commodity M bought by the customer is put. On the other hand, another placing surface thereof at the down stream side is a space for placing a shopping basket 7 in which a commodity M registered by the commodity reading apparatus 1 is put.

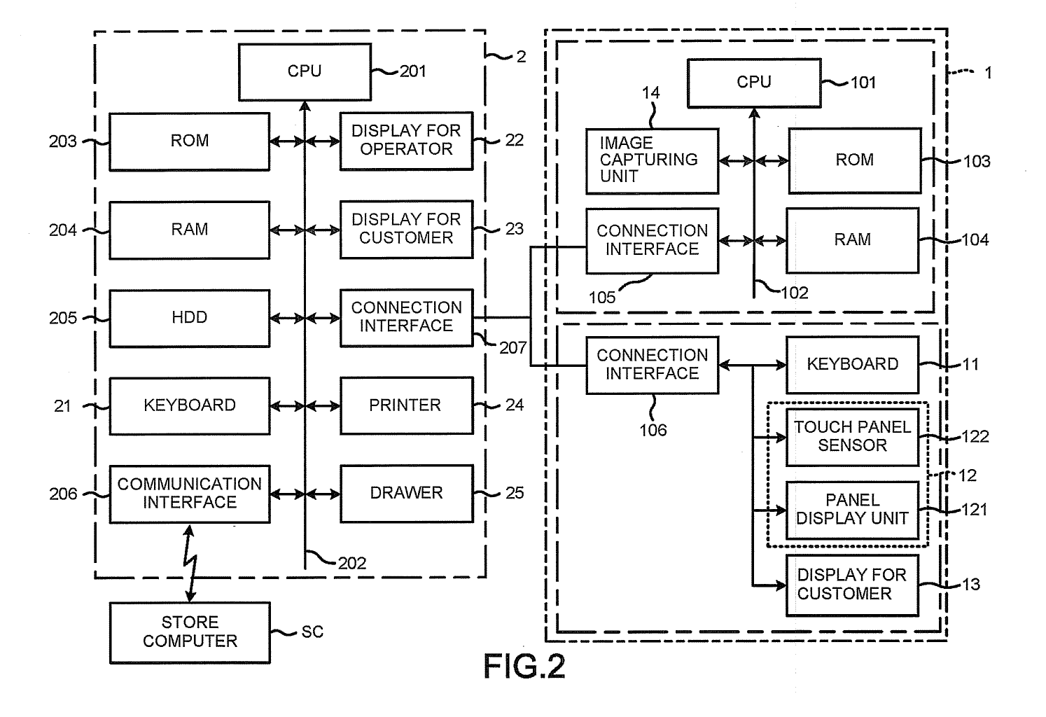

FIG. 2 is a block diagram showing a hardware component of the commodity reading apparatus 1 and the POS terminal 2. The commodity reading apparatus 1 is equipped with a CPU (Central Processing Unit) 101 as a main body of control unit. Then, a ROM 103 and a RAM 104 are connected to the CPU 101 via a bus line 102 such as an address bus and a data bus. A program executed by the CPU 101 is stored in the ROM 103.

The image capturing unit 14 is connected to the bus line 102 via an input and output circuit (not shown). In addition, the keyboard 11, i.e., a display and operation device, the touch panel 12 and the display for customer 13 are connected to the bus line 102 via a connection interface 105 and a connection interface 106. The touch panel 12 includes, for example, a panel display unit 121 that uses a liquid crystal display, and a touch panel sensor 122 that is overlaid on the screen of the display unit.

The POS terminal 2 is also equipped with a CPU 201 as a main body of the control unit. And a ROM 203, a RAM 204, a HDD (Hard Disk Drive) device 205, a communication interface 206 and connection interface 207 are connected to the CPU 201 via a bus line 202. In addition, each unit of the keyboard 21, a display for operator 22, a display for customer 23, a printer 24, and the cash drawer 5 are also respectively connected to the bus line 202 via an input and output circuit (not shown).

The communication interface 206 is connected with a store computer SC via a network such as a LAN (Local Area Network) and the like. The POS terminal 2 can perform the transmission/reception of data to/from the store computer SC through this connection. For example, the POS terminal 2 receives a commodity data file 8 from the store computer SC. The received commodity data file 8 is stored in the HDD device 205.

The connection interface 207 is connected with the two connection interfaces 105, 106 of the commodity reading apparatus 1 via a communication cable. The POS terminal 2 can execute the transmission/reception of data to/from the commodity reading apparatus 1 through this connection. For example, the POS terminal 2 receives the commodity information that is read by the commodity reading apparatus 1. In addition, the POS terminal 2 transmits data in the commodity data file 8 to the commodity reading apparatus 1.

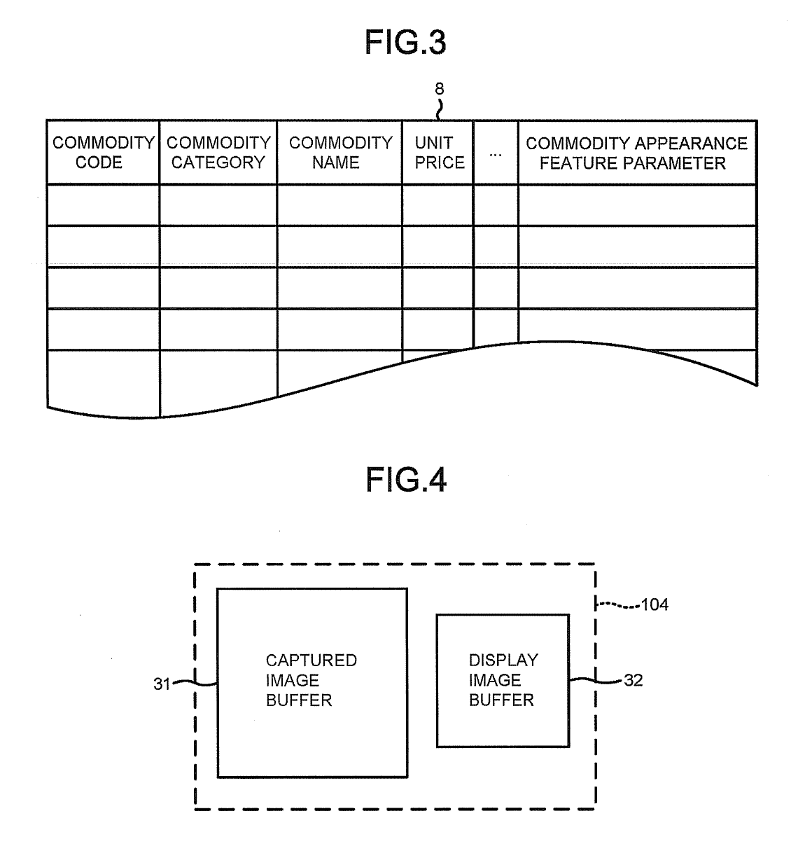

FIG. 3 is a schematic diagram showing a data structure of the commodity data file 8. As shown in FIG. 3, the commodity data file 8 stores the attribute (commodity category), name (commodity name), unit price, and appearance feature parameter etc. of a commodity which are related to a commodity code for recognizing the commodity. The appearance feature parameters digitize features of standard appearance of each commodity, such as the shape, hue, pattern, and surface roughness of the commodity.

In a store checkout system including the commodity reading apparatus 1 and the POS terminal 2 of such construction, an image buffer 31 that stores the image (frame image) of the photographing area S photographed by the image capturing unit 14, and a display image buffer 32 that stores the image displayed on the image display area R (described below) of the panel display unit 121 are formed in the RAM 104 of the commodity reading apparatus 1.

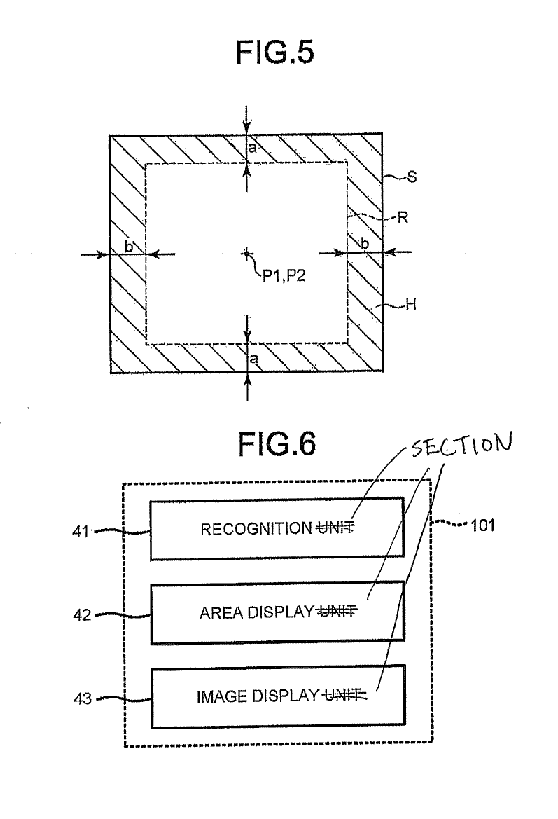

The sizes of the photographing area S and the image display area RS are described by referring to FIG. 5. As shown in FIG. 5, the image display area R is smaller than the photographing area S by width “a” in a vertical direction and by width “b” in a horizontal direction respectively. Accordingly, in case that the center P1 of the photographing area S and the center P2 of the image display area R are coincident and superimposed with each other, an extrusion area (hatching area of FIG. 5) H is generated in the photographing area S by the width “a” in the vertical direction and by the width “b” in the horizontal direction. In addition, the relationship between the width “a” and the width “b” may be a case 1 (width “a”=width “b”), a case 2 (width “a”>width “b”), or a case 3 (width “a”<width “b”).

As shown in FIG. 6, the CPU 101 of the commodity reading apparatus 1 has following functions including a recognition means 41 that recognizes the commodity included in an image photographed by the image capturing unit 14 acting as an image capturing means, an area display means 42 that displays the image display area R being smaller than the photographing area S of the image capturing unit 14 on the screen of the panel display unit 121, and an image display section 43 that displays an image photographed by the image capturing unit 14 in a manner that the center of the image is located at the center of the image display area R. These functions are realized according to the commodity reading program stored in the ROM 103.

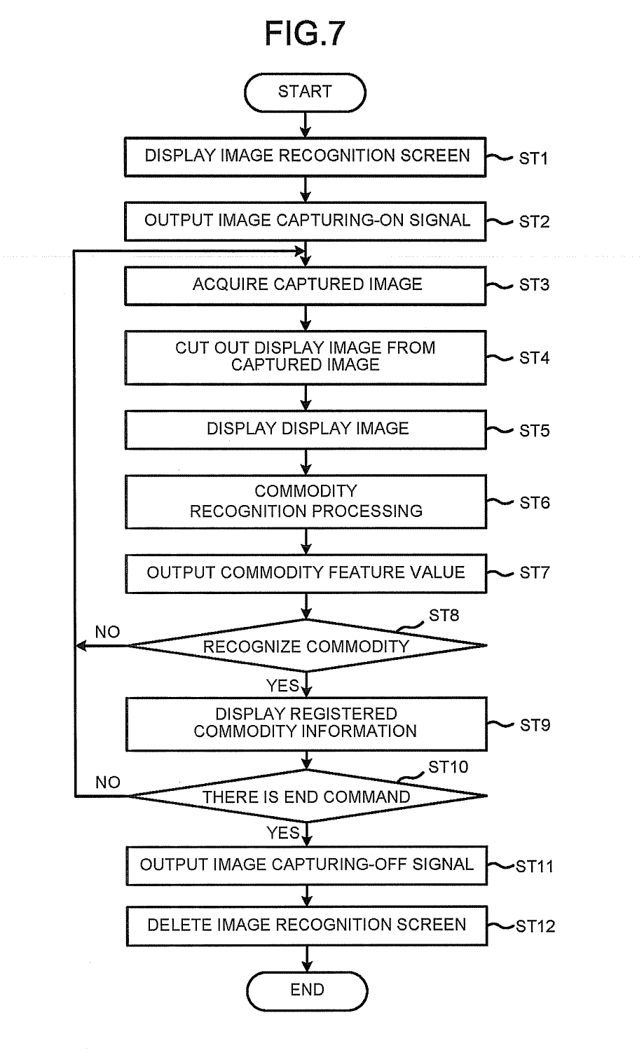

The functions of the CPU 101 described above are described by referring to the flowchart of FIG. 7. The flowchart shows a main procedure of an information processing executed by the CPU 101 according to the commodity reading program.

For example, if a command for instructing start of the commodity registration is input from the POS terminal 2 via a connection interface 105, the processing is started. First, the CPU 101 displays an image recognition screen 50 on the panel display unit 121 of the touch panel 12 (ST1).

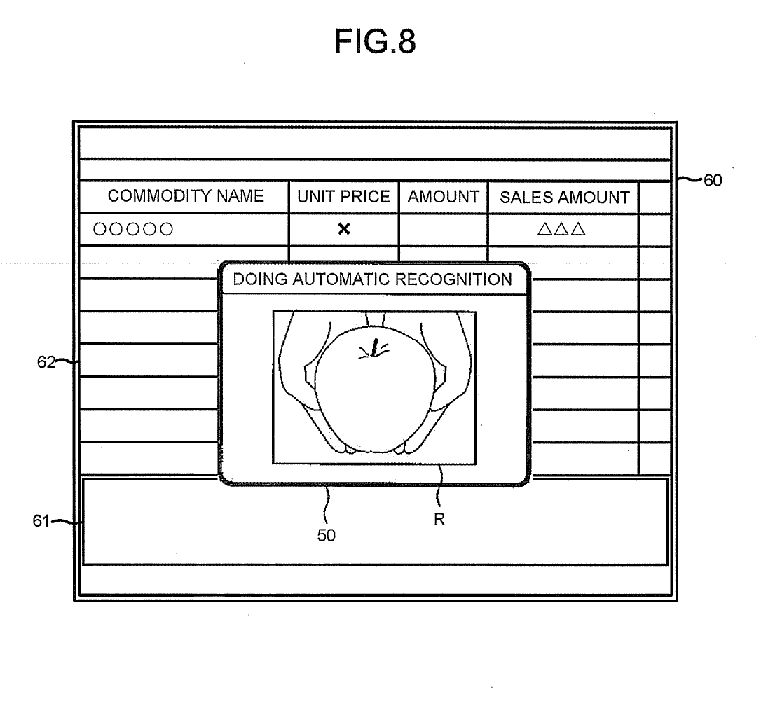

One example of the image recognition screen 50 is shown in FIG. 8. As shown, the image recognition screen 50 includes the image display area R, and it is superimposed on a registration screen 60 and displayed in a pop-up manner. The registration screen 60 comprises a current area 61 and an item area 62. The current area 61 is an area for displaying commodity name, unit price, amount, sales amount of the newly registered commodity. The item area 62 is an area for displaying commodity name, unit price, amount, and sales amount of each commodity registered in one transaction.

Next, the CPU 101 outputs a capturing-on signal to the image capturing unit 14 (ST2). The image capturing unit 14 starts to photograph the photographing area S in response to the capturing-on signal. The frame images of the photographing area S photographed by the image capturing unit 14 are successively saved into the image buffer 31.

The CPU 101 acquires the frame image saved in the image buffer 31 (ST3). And, a display screen in which the extrusion area H is removed from the frame image is clipped (ST4). The data of the clipped display image is stored in the display image buffer 32. The CPU 101 displays the display image stored in the display image buffer 32 in the image display area R of the image recognition screen 50 (ST5). At this time, the CPU 101 displays the display image in a manner that the center of the image is located at the center of the image display area R.

As previously mentioned, the display image is produced by removing the part of the extrusion area H from the frame image. The extrusion area H is a protruding part in case that centers of the photographing area S and the image display area R are coincident and superimposed with each other. Thus, by performing the display in a manner that the center of the display image is located at the center of the image display area R, the display image clipped from the frame image is completely displayed in the image display area R.

Next, the CPU 101 recognizes the commodity M included in the image from the frame image taken out of the image buffer 31 (ST6). Specifically, the CPU 101 first detects whether or not there is a skin tone or a flesh color area in the frame image. If the flesh color area is detected, that is, the hand of an operator that is imaged into the frame image is detected, the CPU 101 extracts the outline of the flesh color area from the image that is obtained by binarising the frame image. In this way, the CPU 101 tries to extract the outline of the commodity M that is assumably held by the hand of the operator. If the outline of the commodity M is extracted, the CPU 101 reads feature data (characteristic amount) such as the shape, hue, pattern, and surface roughness of the commodity M from the image within the outline. If these commodity features can be read, the CPU 101 determines that the commodity M is recognized. The CPU 101 repeats the commodity recognition processing to the frame image displayed in a display area 51 until the commodity M can be recognized.

The technology for recognizing an object included in such image is called “generic object recognition”. As for the technology of the generic object recognition, various recognition technologies rare illustrated in the following literature.

YANAI Keiji, “The present situation and future of generic object recognition”, Journal of information processing society, Vol. 48, No. SIG16 [retrieved on Aug. 10, 2010], Internet <URL: http://mm.cs.uec.ac.jp/IPSJ-TCVIM-Yanai.pdf>

In addition, the technology of generic object recognition by area-dividing an image in every object is illustrated through the literatures described below.

Jamie Shotton etc., “Semantic Texton Forests for Image Categorization and Segmentation”, [retrieved on Aug. 10, 2010], Internet

<URL:http://citeseerx.ist.psu.edu/viewdoc/download?doi=

10.1.1.145.3036&rep=repl&type=pdf>

If the commodity M can be recognized from the frame image, the CPU 101 outputs the feature data (characteristic amount) of the recognized commodity M to the POS terminal 2 (ST7)

If the feature data of the commodity M is input from the commodity reading apparatus 1, the CPU 201 of the POS terminal 2 checks the feature data with the commodity appearance feature parameter of each commodity stored in the commodity data file 8. And, the CPU 201 determines that the commodity having an appearance feature parameter most similar to the feature data of the commodity M is the commodity M.

When the commodity M is determined, the CPU 201 reads out the commodity code, commodity name, unit price of the commodity M from the commodity data file 8. Then, the CPU 201 calculates the sales amount by setting the number of sales items as “1”. And the CPU 201 performs the registration process in which the commodity sales data including the commodity code, commodity name, unit price, number of sales items, and sales amount etc. are registered into the RAM 204. In addition, the CPU 201 outputs the commodity sales data as the determined commodity information to the commodity reading apparatus 1 via the connection interface 207.

At the ACT ST8, the CPU 101 that outputs the feature data of the commodity M to the POS terminal 2 waits for the determined commodity information (ST8). When the CPU 201 receives the determined commodity information from the POS terminal 2 via the connection interface 105 (YES in ST8), the CPU 101 displays the determined commodity information including the commodity code, commodity name, unit price, number of sales items, sales amount etc. of the determined commodity M in the current area of the registration screen 60 (ST9). Then, the CPU 101 determines weather or not a command instructing termination of the commodity registration is input (ST10). If the termination command is not input (NO in ST10), the CPU 101 acquires the next frame image from the RAM 104 (ST3).

The termination command is output from the POS terminal 2 to the commodity reading apparatus 1 in response to the input operation of the [TOTAL] key arranged on the keyboard 11, for example. That is, if a key signal of the [TOTAL] key is input from the commodity reading apparatus 1, the CPU 201 of the POS terminal 2 outputs the termination command to the commodity reading apparatus 1. In addition, the CPU 201 performs the registration closing processing of one transaction based on the commodity sales data registered in the RAM 204.

When the termination command is input via a connection interface 105 (YES in ST10), the CPU 101 outputs a capturing-off signal to the image capturing unit 14 (ST11). The CPU 101 deletes the image recognition screen 50 from the panel display unit 121 (ST12). The image capturing unit 14 terminates the photographing of the photographing area.

In this way, the commodity reading apparatus 1 constitutes the recognition apparatus section 41 by performing the processing of ACT ST6 in the information processing procedure executed by the CPU 101 according to the commodity reading program, the area display section 42 by performing the processing of ACT ST1, and the image display section 43 by performing the processing of the ACT ST5.

When the cashier of the store in which the store checkout system of the present embodiment is adopted takes out an un-registered commodity M out of the shopping basket 6, then the commodity M is hold over the reading window 1B of the commodity reading apparatus 1. Then, an image photographed by the image capturing unit 14 is displayed within the image display area R of the image recognition screen 50 displayed on the touch panel 12.

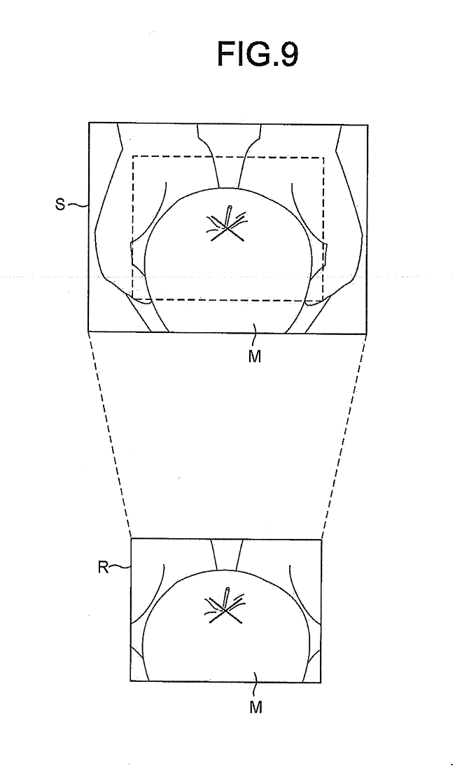

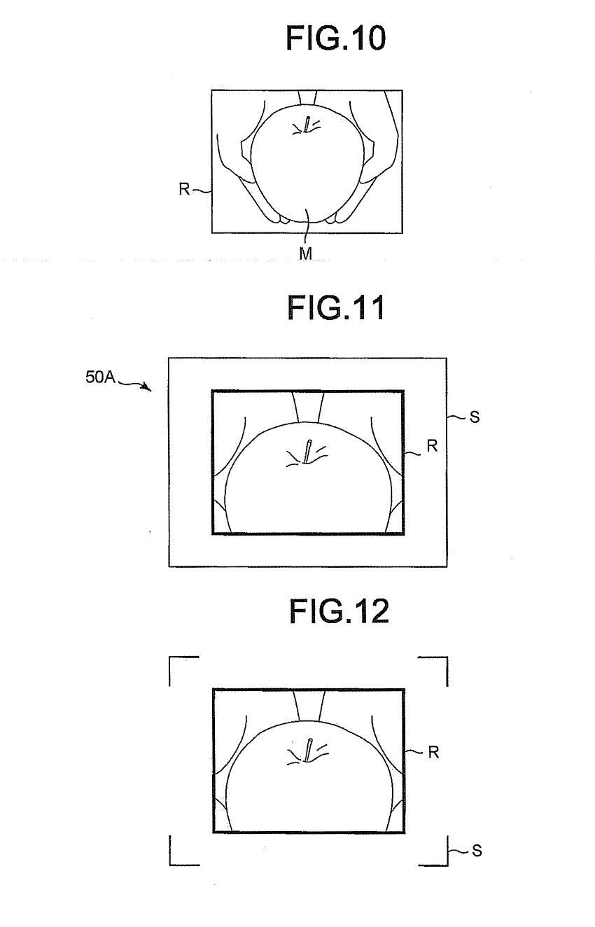

The image in the photographing area S within the imaging image capturing unit 14, and the image in the image display area R under the above state are shown in FIG. 9. As shown in the Fig., the commodity M (Apple) and the right and left palms of the operator who holds the commodity is photographed by the image capturing unit 14, but an image in which an image of the extrusion area H is removed from the image of the photographing area S is displayed in the image display area R. That is, the image photographed by the image capturing unit 14 shows an image from which the lower side of the commodity M is lacked somewhat thereof, but the image displayed in the image display area R shows an image from which a half of the lower side of the commodity M is lacked. Thus, the operator who confirms the image moves his or her hands so that the overall appearance of the commodity M is shown within the image display area R, as shown in FIG. 10. For example, the hands holding the commodity M is slightly moved away from the reading window 1B.

Thus, the overall appearance of the commodity M is shown in the image display area R. At this time, since the photographing area S is larger than the image display area R, the overall appearance of the commodity M is included in the image photographed by the image capturing unit 14. Therefore, the commodity is reliably recognized by the commodity recognizing processing in ACT ST6.

In this way, according to the present embodiment, the image display area R smaller in size than the photographing area of the image capturing unit 14 is displayed on the screen, and the image photographed by the image capturing unit 14 is displayed in a manner that the center of the image is located at the center of the image display area R, thus the operator can be guided such that the commodity M is located at the center of the reading window 1B. As a result, even an operator who is unskilled in the operation can hold the commodity in a short period so as to photograph the overall appearance of the commodity M by the image capturing unit 14, thus the period for recognizing the commodity can be shortened.

The invention is not limited to the embodiments described above.

For example, in the above-described embodiments, although the image display area R smaller in size than the photographing area S is displayed in the image recognition screen 50, the frame for indicating the photographing area S may be displayed at the outside of the frame for indicating the image display area R, as shown in FIG. 11. By doing so, the operator who holds the commodity M over the reading window 1B can certainly confirm the relationship in position of photographing area S relative to the image display area R, thus he or her can hold the commodity so as to photograph the overall appearance of the commodity M more easily by the image capturing unit 14.

In the display example shown in FIG. 11, it is more preferable to display the image display area R that the frame for indicating the image display area R is highlighted with respect to the photographing area S. That is, the image display area R is certainly shown more than the photographing area S, thus the operator does not judge in mistake the frame for indicating the photographing area S as the frame for indicating the image display area R.

As the method for highlighting the frame for indicating the image display area R with respect to the frame for indicating the photographing area S, a method in which the frame for indicating the image display area R with respect to the photographing area S is thickened, or a method in which the frame for indicating the image display area R is set to a distinct color such as black and the frame for indicating the photographing area S is set to an un-distinct color such as grey are considered. Alternatively, as shown in FIG. 12, only four corners of the frame that indicates the photographing area S may be shown. In addition, the extrusion area H between the photographing area S and the image display area R is grayed (display in gray color), and the frame for indicating the photographing area S may be a normal display as described above.

The present embodiment is applied to the commodity reading apparatus 1 on the checkout counter handled by a cashier, but the application example is not limited to this. For example, the embodiment may be applied to a commodity reading apparatus of a self checkout system in which a customer carries out the checkout operation by itself. In addition, the commodity reading apparatus 1 may be packaged in the POS terminal 2 as an integrated construction. In short, the present invention can be applied to a checkout system that consists of the commodity reading apparatus 1 and the POS terminal 2.

In the above-described embodiments, the technology that recognizes the commodity M is described, but the object as a recognized target is not limited to a commodity. For example, the present invention can also be applied to the recognition for the data code affixed to a commodity such as a barcode or a two dimensional code.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity reading apparatus, comprising:
a display section having a screen;
an image capturing unit configured to photograph a commodity in a photographing area to output an image of the photographing area;
a recognition unit configured to recognize the commodity that is included in the image outputted by the image capturing unit;
an area display unit configured to display an image display area smaller in size than the photographing area photographed by the image capturing unit on the screen of the display section; and
an image display unit configured to display the image photographed by the image capturing unit on the screen in a manner that the center of the image is located at the center of the image display area.

2. The apparatus according to claim 1, wherein the area display unit further displays a first frame for indicating the photographing area by the image capturing unit at the outside of the image display area on the screen.

3. The apparatus according to claim 2, wherein the area display unit displays, in a highlighting manner, a second frame for indicating the image display area to the first frame for indicating the photographing area.

4. A commodity reading method, including:
photographing an image of a photographing area;
recognizing a commodity included in the image of the photographing area that is photographed;
displaying an image display area smaller in size than the photographing area on a display screen; and
displaying the image of the commodity recognized on the display screen in a manner that the center of the image is located at the center of the image display area.

5. The method according to claim 4, wherein the displaying the image display area further displays a first frame for indicating the photographing area at the outside of the image display area on the display screen.

6. The method according to claim 5, wherein the displaying the image display area displays in a highlighting manner a second frame for indicating the image display area to the first frame for indicating the photographing area on the display screen.
